(19) United States
(12) Patent Application Publication
(10) Pub. No.: US 2011/0032697 A1
(43) Pub. Date: Feb. 10, 2011

(54) LED lighting device module and LED lighting device

(76) Inventors: Sheng-Hsiung Hu, Shanhua Township (TW); Yu-Yuan Yeh, Banqiao (TW); Ching-Po Lee, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/585,124

(22) Filed: Sep. 4, 2009

(30) Foreign Application Priority Data
Aug. 5, 2009 (TW) 98126344

(51) Int. Cl. F21L 4/00

(52) U.S. Cl. 362/190; 362/373

(57) ABSTRACT

An LED light device module includes a housing, a light source structure and a power supply. The housing has a cover body and a base body. The cover body is located on the base body. The light source structure is located in the housing. The light source structure includes a cooling device, an LED light source device and a secondary optical device. The LED light source device and the secondary optical device are located on the cooling device. The LED light source device is located between the cooling device and the secondary optical device. The power supply is located in the housing and electrically connected with the light source structure. Thereby, the system cost is reduced, the total weight is low, it is easy to manufacture and maintain. The LED light device module can be expanded and the outline of the LED light device module can be designed flexibly.

### BACKGROUND OF THE INVENTION

1. Field of the Invention

The present invention relates to an LED lighting device module and an LED lighting device. In particular, the present invention relates to an LED lighting device module and an LED lighting device that can be expanded, easily maintained and its outline can be flexibly designed.

2. Description of Related Art

Because LED has a lot of merits, such as brightness is high, consumption power is low, and usage life is long, etc, LED is popularly applied to a variety of lighting devices, such as an LED lighting device for lighting a road. When LED is lighting, a great amount of heat is generated so that a cooling device is required to exhaust the heat. Therefore, LED can light under a proper temperature and does not burn down. When the cooling device is not designed well, high temperature will lower the brightness of LED, reduce the usage life, and change the wavelength. Furthermore, because the height and the required brightness of the lighting devices are different for different environments and the optical specifications are also different, LED lighting devices needs to be easily maintained and easily assembled, and the optical type and the brightness of the LED lighting device can easily be changed, in addition to the cooling function. Moreover, the outline of the LED lighting device can be designed to replace the wall lamps or scenery lamps.

Reference is made to FIG. 1, the LED lighting device of the prior art has the following problems.

1. The LED lighting device 1a of the prior art usually has a housing 11a and an LED light source device 12a. The LED light source device 12a is directly pasted onto the housing 11a. The light source emits from the bottom of the housing 11a. The housing 11a has a cooling fin 111a with a large dimension to directly exhaust heat to air. However, dust will be accumulated on the housing 11a to affect the cooling effect. Moreover, the thickness of the housing 11a needs to be increased to make the heat be distributed uniformly and the housing 11a is made of heat-conductive metal. The cost and the weight increases.

2. The secondary optical design of the LED light source device 12a is a single mask. It is not easily expanded.

3. When the outline of the housing 11a needs to be changed, the structure of the LED lighting device 1a needs to be changed and the cooling device also needs to be changed.

4. A cooling pipe (not shown in the figure) is used to exhaust the heat of the LED. That will increase the cost and it is difficult to maintain the LED lighting device. Furthermore, due to the system dimension is increased and the LED lighting device becomes complex, it is not to assemble the LED lighting device.

### SUMMARY OF THE INVENTION

One particular aspect of the present invention is to provide an LED lighting device module and an LED lighting device. Its structure is simple, and the cost is reduced. The total weight is low, the heat can be easily exhausted, the LED lighting device can be easily manufactured and maintained, the LED lighting device can be expanded and the outline of the LED lighting device can be easily changed.

The LED lighting device module includes a housing having a cover body and a base body, a light source structure located in the housing, and a power supply located in the housing and electrically connected with the light source structure. The cover body is located on the base body. The light source structure includes a cooling device, an LED light source device and a secondary optical device. The LED light source device and the secondary optical device are located on the cooling device. The LED light source device is located between the cooling device and the secondary optical device.

The present invention also provides an LED light device that includes a pole and a plurality of LED lighting device modules. Each of the LED lighting device modules is located on the pole. The LED lighting device module includes a housing having a cover body and a base body, a light source structure located in the housing, and a power supply located in the housing and electrically connected with the light source structure. The cover body is located on the base body. The light source structure includes a cooling device, an LED light source device and a secondary optical device. The LED light source device and the secondary optical device are located on the cooling device. The LED light source device is located between the cooling device and the secondary optical device.

The present invention has the following characteristics.

1. Because the light source structure and the power supply are located in the housing and the light source structure has a cooling device for exhausting heat, the housing is not used for exhausting heat. The material of the housing is not limited to a heat-conductive material and is not limited to be cast by metal. Both the cost and the weight are reduced.

2. The outline of the housing is not limited to a specific type. According to the requirement, a plurality of LED lighting devices can be installed on the pole of the lighting device. The brightness is increased. The lighting device can be designed flexibly.

3. The cover body is pivoted with the base body. When the lighting device is failed, the user merely needs to open the cover body to maintain the lighting device. The LED lighting device modules do not affect each other. The user merely needs to disassemble or replace the failed LED lighting device module. It is easy to maintain the lighting device.

4. The cooling device for each of the LED lighting device modules is independent, and is not affected by the outline or the quantity of the LED lighting device modules. Each of the LED lighting device modules can exhaust heat well and the temperature is distributed uniformly.

5. The powers of the LED lighting device modules are independent so that the heat is distributed normally. The cooling effect is good. When one of the power supplies is failed, the lighting function of the lighting device will not fail due to just one the LED lighting device module is failed.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a schematic diagram of the LED lighting device of the prior art;

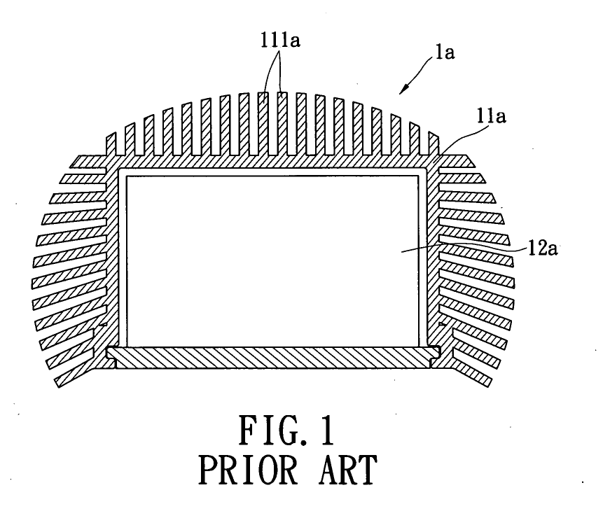

FIG. 2 is a perspective view of the LED lighting device module of the present invention;

FIG. 3 is another perspective view of the LED lighting device module of the present invention;

FIG. 4 is an exploded perspective view of the LED lighting device module of the present invention;

FIG. 5 is a cross-sectional diagram of the LED lighting device module of the present invention;

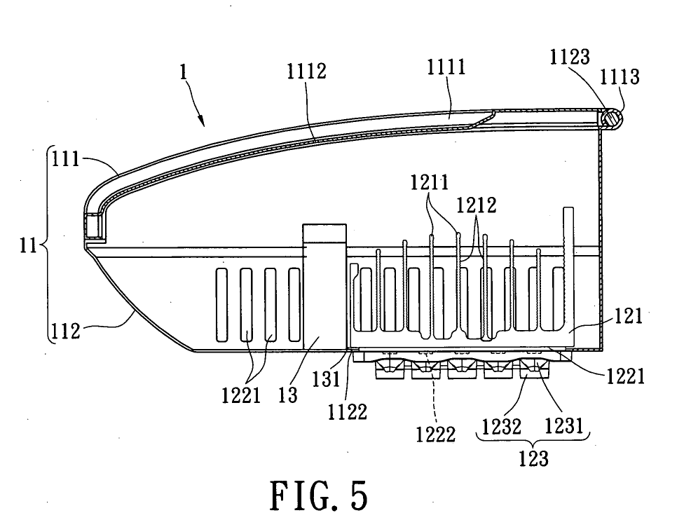

FIG. 6 is a schematic diagram of the usage status of the LED lighting device module of the present invention;

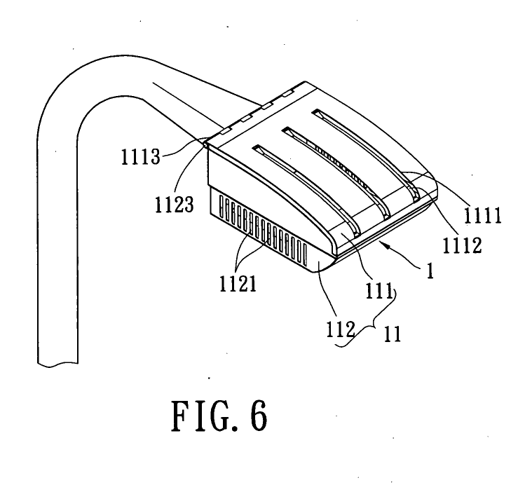

FIG. 7 is a perspective view of the LED lighting device of the present invention;

FIG. 8 is an exploded perspective view of part of the LED lighting device of the present invention; and

FIG. 9 is a schematic diagram of the housing of the LED lighting device module of the second embodiment of the present invention.

### DETAILED DESCRIPTION OF THE PREFERRED EMBODIMENTS

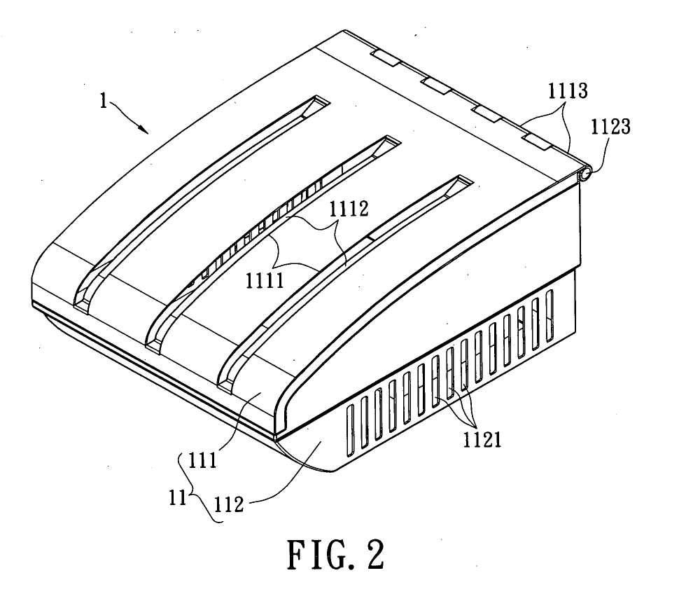

Reference is made to FIGS. 2˜6. The LED lighting device module 1 includes a housing 11, a light source structure 12 and a power supply 13.

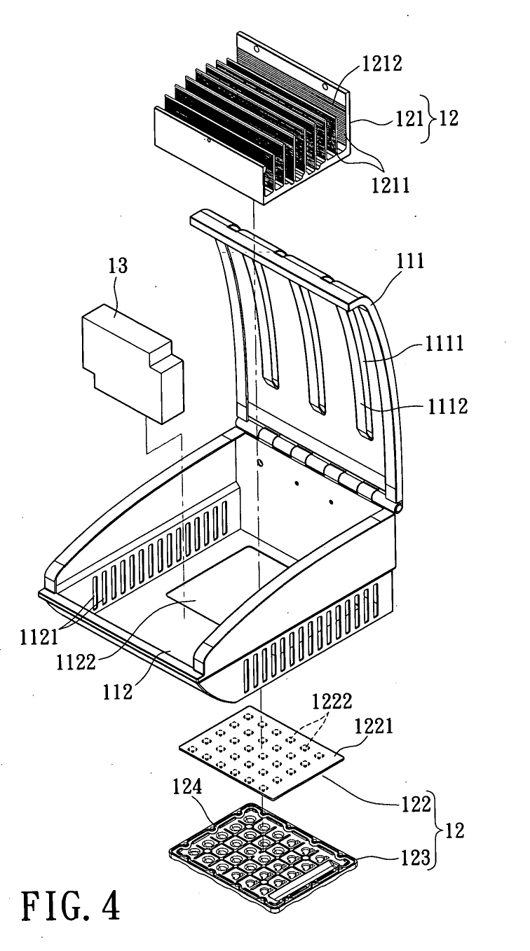

In this embodiment, the housing 11 is a hollow box. The material of the housing 11 is not limited to a heat-conductive material. For example, it can be a plastic part. The housing 11 includes a cover body 111 and a base body 112. The cover body 111 has a plurality of air outlets 1111, a plurality of concave portions 1112 and a plurality of pivoting portions 1113. The air outlets 1111 are bar-shaped and disposed on the top of the cover body 111 at intervals. The concave portions 1112 are respectively located at the air outlets 1111 and its height is lower than the cover body 111. The concave portion 1112 has a streamline shape and two ends of concave portion 1112 are respectively connected with the cover body 111 for preventing dust or rain from directly entering the housing 11. The pivoting portions 1113 extend and roll up to be formed at one side of the cover body 111 that is higher. Two sides of the base body 112 have a plurality of air inlets 1121. The bottom of the base body 112 has an opening 1122 (referring to FIG. 4). One side of the base body 1112 that corresponds to the pivoting portion 1113 of the cover body 111 has a pivoting shaft 1123. The pivoting portion 1113 is pivoted with the pivoting shaft 1123 so that the cover body 111 is pivoted with the base body 112.

The light source structure 12 is located around the opening 1122 of the base body 112 and is located in the housing 11. The light source structure 12 includes a cooling device 121, an LED light source device 122 and a secondary optical device 123. In this embodiment, the cooling device 121 is squeezed by aluminum that is a heat-conductive material. The cooling device 121 has a plurality of cooling fins 1211. The cooling fins 1211 are disposed at intervals and a high-to-low level. The surface of the cooling fin 1211 has a plurality of wave-shaped structures 1212 to increase the cooling area.

The LED light source device 122 has a metal core printed circuit board (MCPCB) 1221 and a plurality of LEDs 1222. The printed circuit board 1221 is locked onto the cooling device 121. The LEDs 1222 are disposed on the printed circuit board 1221 at intervals to provide the light source. Cooling grease (not shown in the figure) is coated between the LEDs 1222 and the cooling device 121 for exhausting heat.

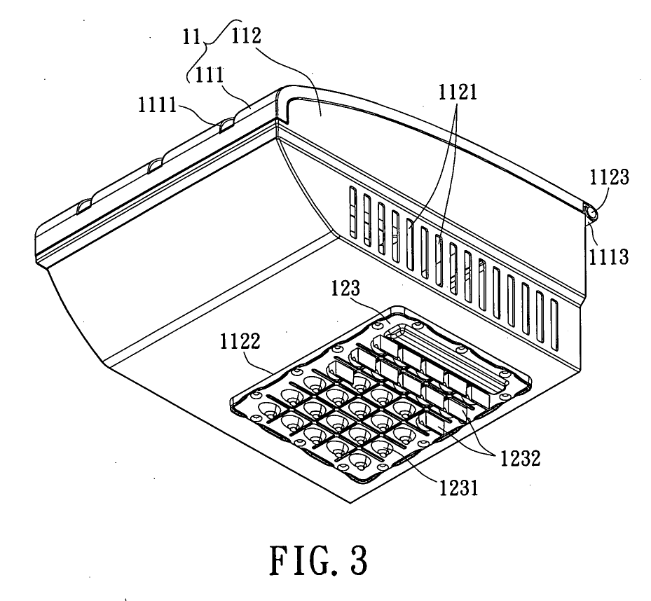

In this embodiment, the secondary optical device 123 is transparent and rectangular. The dimension of the secondary optical device 123 is larger than the dimension of the opening 1122 of the base body 112 and the printed circuit board 1221. The secondary optical device 123 is locked onto the cooling device 121, and the LED light source device 122 is located between cooling device 121 and the secondary optical device 123. The bottom of the secondary optical device 123 has a plurality of light-adjusting structures 1231 and a plurality of light-polarizing structures 1232 (as shown in FIG. 3). The light-adjusting structures 1231 and the light-polarizing structures 1232 extend to outside of the opening 1122. The light-adjusting structures 1231 are core-shaped, and correspond to the LEDs 1222 for focusing the light source to increase the brightness. The light-polarizing structures 1232 are flake-shaped, and are vertically located at one side of part of the light-adjusting structures 1231 for adjusting the direction of the light source to light the target area. The outer area of the secondary optical device 123 has a rubber ring for preventing water from entering the lighting device.

The power supply 13 is fastened onto the base body 112 and is located at one side of the light source structure 12. The power supply 13 is electrically connected with the light source structure 12 via conductive wire 131 for providing power.

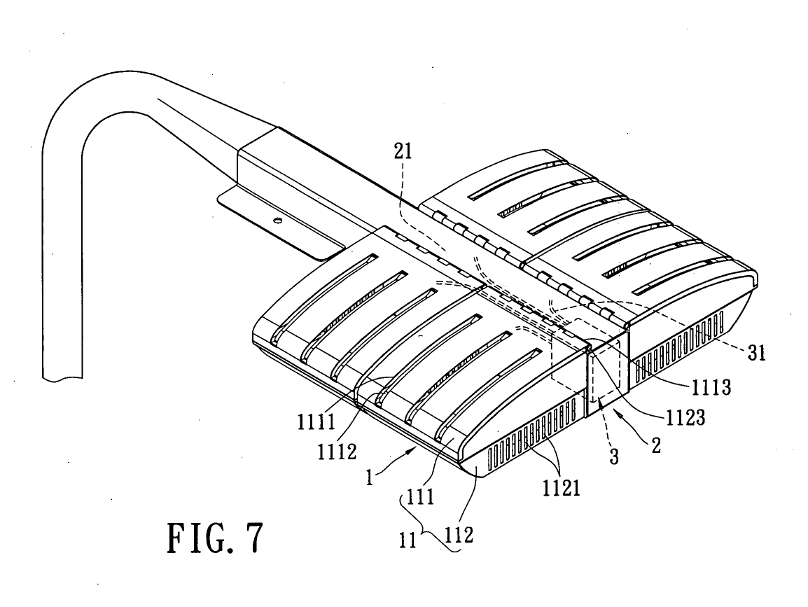

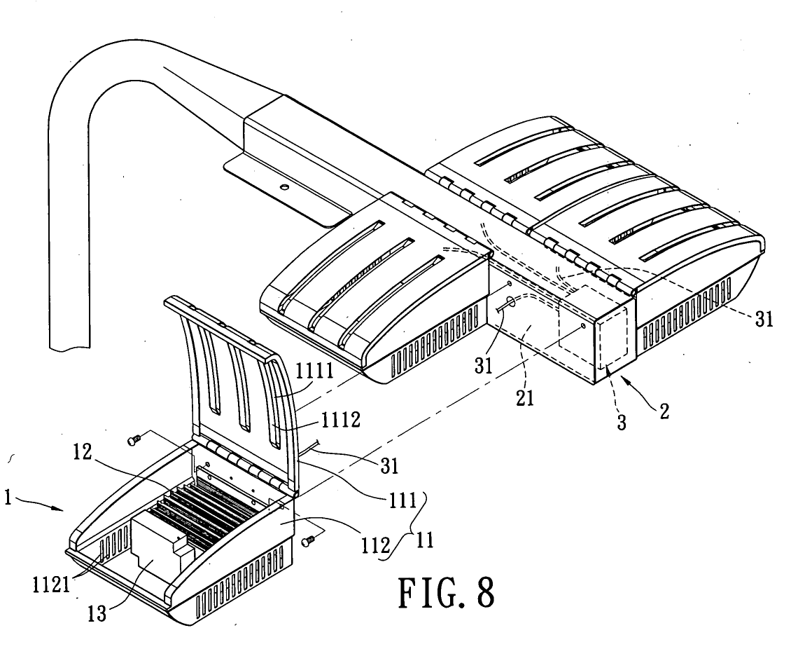

Reference is made to FIGS. 7 and 8. The LED lighting device includes a pole 2 and a plurality of LED lighting device modules 1. In this embodiment, the front end of the pole 2 has a receiving space 21. The receiving space 21 has an electric equipment room 3. The electric equipment room 3 is electrically connected with the power supply 13 in the LED lighting device module 1 via an electric wire 31 to connect each module in serial. The electric wire 31 is located in the receiving space 21. Two sides of the pole 2 respectively are locked with an LED lighting device module 1 by screw and the LED lighting device modules 1 are symmetrically disposed. The quantity of the LED lighting device modules 1 depends on the requirement to meet the brightness and achieve the expanding effect. The LED lighting device module 1 includes a housing 11, a light source structure 12 and a power supply 13. The housing 11, the light source structure 12 and the power supply 13 are the same as the previous embodiment, not repeated again.

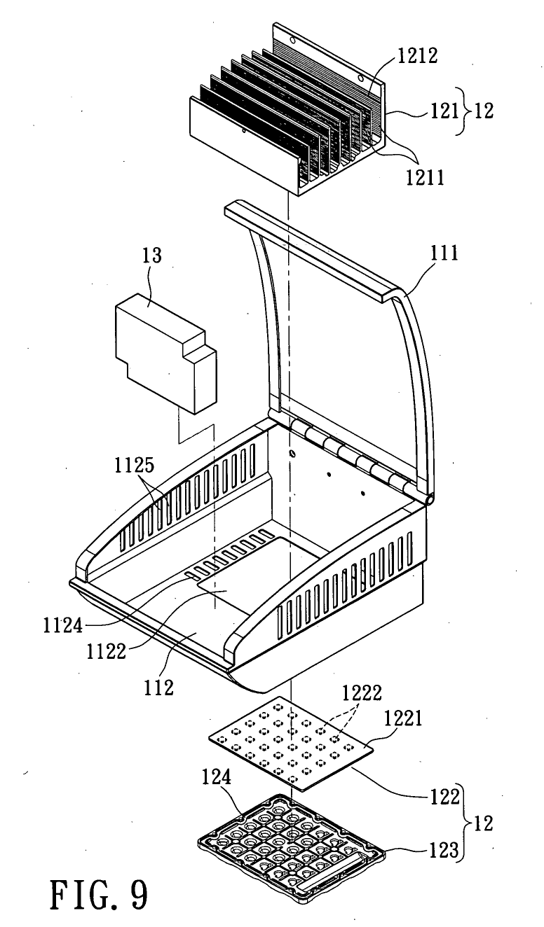

Reference is made to FIG. 9. The difference between this embodiment and the previous embodiment is described as followings. The bottom of the base body 112 has a plurality of air inlets 1124. The air inlets 1124 are adjacent to the opening 1122 and are located at two sides of the cooling fin 12 to enhance the cooling effect. The upper half of two side walls of the base body 112 has a plurality of air outlets 1125.

The LED lighting device module and the LED lighting device of the present invention has the following characteristics.

1. Because the light source structure 12 is located in the housing 11 and the light source structure 12 has a cooling device 121 for exhausting heat, the housing 11 is not used for exhausting heat and merely has the air inlet 1121 and the air outlet 1111 for flowing air. The material of the housing 11 is not limited to a heat-conductive material and is not limited to be cast by metal. Both the cost and the weight are reduced.

2. The outline of the housing 11 for receiving the light source structure 12 and the power supply 13 is not limited to a specific type. A plurality of LED lighting device modules can be installed on the pole 2 of the lighting device to increase the brightness. The lighting device can be designed flexibly.

3. The cover body 111 is pivoted with the base body 112. When the lighting device is failed, the user merely needs to open the cover body 111 to maintain the lighting device. It is very convenient. The LED lighting device modules 1 do not affect each other. The user merely needs to disassemble or replace the failed LED lighting device module 1. It is easy to maintain the lighting device.

4. The streamline shaped concave portions 1112 are located around the air outlet 1111. The height of the concave portions 1112 is lower than the height of the cover body 111 so that dust and rain do not directly enter into the housing 11 to achieve the dust-proof effect and waterproof effect.

5. The receiving space 21 of the pole 2 has the electric equipment room 3. The electric equipment room 3 is electrically connected with the power supply 31 of the LED lighting device module 1 via an electric wire 31 to connect each module in series and prevent the voltage from accumulating. The power of the power supply is reduced to distribute heat. The power supply with low power is easily manufactured. Moreover, because the electric wire 31 is located in the receiving space 21, the quality of the electric wire 31 does not change.

6. The cooling device for each of the LED lighting device modules is independent, and is not affected by the outline or the quantity of the LED lighting device modules. Each of the LED lighting device modules can exhaust heat well and the temperature is distributed uniformly.

7. The power sources of the LED lighting device modules are independent so that the heat is distributed normally. The cooling effect is good. When one of the power supplies is failed, the lighting function of the lighting device will not fail due to just one the LED lighting device module is failed.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. An LED light device, comprising:
a pole; and
a plurality of LED lighting device modules, wherein each of the LED lighting device modules is located on the pole and the LED lighting device module includes:
a housing having a cover body and a base body, wherein the cover body is located on the base body;
at least one air inlet and at least one air outlet;
a light source structure located in the housing, wherein the light source structure includes a cooling device, an LED light source device and a secondary optical device, the LED light source device and the secondary optical device are located on the cooling device, and the LED light source device is located between the cooling device and the secondary optical device; and
a power supply located in the housing and electrically connected with the light source structure.

2. The LED light device as claimed in claim 1, wherein the air inlets are located on the housing that is adjacent to the lower half of the cooling device, the air outlets are located above the air inlets, the bottom of the base body has an opening, and the light source structure is located in the opening.

3. The LED light device as claimed in claim 1, wherein the air outlet has a plurality of concave portions, and the height of the concave portions is lower than the height of the cover body.

4. The LED light device as claimed in claim 1, wherein the cooling device has a plurality of cooling fins, the cooling fins are disposed at intervals and are in a high-to-low status, and the surface of the cooling fins has a plurality of wave-shaped structures.

5. The LED light device as claimed in claim 1, wherein the LED light source device has a printed circuit board and a plurality of LEDs, and the LEDs are located on the printed circuit board.

6. The LED light device as claimed in claim 1, wherein the secondary optical device has a plurality of light-adjusting structures and a plurality of light-polarizing structures, the light-adjusting structures correspond to the LEDs, and the light-polarizing structures are located at one side of part of the light-adjusting structures.

7. The LED light device as claimed in claim 1, wherein the pole has a receiving space, the receiving space has an electric equipment room, and the electric equipment room is respectively and electrically connect the power supply of each of the LED lighting device modules.

8. The LED light device as claimed in claim 1, wherein the LED lighting device modules are symmetrically located at two sides of the pole.

9. An LED light device module, comprising:
a housing having a cover body and a base body, wherein the cover body is located on the base body;
at least one air inlet and at least one air outlet;
a light source structure located in the housing, wherein the light source structure includes a cooling device, an LED light source device and a secondary optical device, the LED light source device and the secondary optical device are located on the cooling device, and the LED light source device is located between the cooling device and the secondary optical device; and
a power supply located in the housing and electrically connected with the light source structure.

10. The LED light device module as claimed in claim 9, wherein the air inlets are located on the housing that is adjacent to the lower half of the cooling device, the air outlets are located above the air inlets, the bottom of the base body has an opening, and the light source structure is located in the opening.

11. The LED light device module as claimed in claim 9, wherein the air outlet has a plurality of concave portions, and the height of the concave portions is lower than the height of the cover body.

12. The LED light device module as claimed in claim 9, wherein the cooling device has a plurality of cooling fins, the cooling fins are disposed at intervals and are in a high-to-low status, and the surface of the cooling fins has a plurality of wave-shaped structures.

13. The LED light device module as claimed in claim 9, wherein the LED light source device has a printed circuit board and a plurality of LEDs, and the LEDs are located on the printed circuit board.

14. The LED light device module as claimed in claim 9, wherein the secondary optical device has a plurality of light-adjusting structures and a plurality of light-polarizing structures, the light-adjusting structures correspond to the LEDs, and the light-polarizing structures are located at one side of part of the light-adjusting structures.
